(19) United States
(12) Patent Application Publication
(10) Pub. No.: US 2011/0298845 A1
(43) Pub. Date: Dec. 8, 2011

(54) PANEL CONTROLLER, LIQUID CRYSTAL DISPLAY APPARATUS, SIGNAL MODULATION METHOD, SIGNAL MODULATION PROGRAM, AND RECORDING MEDIUM

(75) Inventor: Masahiro Arai, Osaka-shi (JP)

(73) Assignee: SHARP KABUSHIKI KAISHA, OSAKA (JP)

(21) Appl. No.: 13/201,602

(22) PCT Filed: Oct. 29, 2009
(86) PCT No.: PCT/JP2009/068558

§ 371 Date: Aug. 15, 2011

(30) Foreign Application Priority Data
Mar. 9, 2009 (JP) 2009-054411

(51) Int. Cl. G09G 5/10; G09G 3/36

(52) U.S. Cl. 345/690; 345/102

(57) ABSTRACT

The object of the invention is to prevent a large amount of unnecessary images from being displayed on an image on a liquid crystal display panel, due to a signal value of a pulse width modulation signal (PWM) which exceeds the minimum signal value of a vertical synchronization signal when the vertical synchronization signal (VS) interferes with the pulse width modulation signal (PWM) within a period of one frame. A liquid crystal display panel controller makes an intermediate signal value (M1) of the vertical synchronization signal (VS) higher than the maximum signal value (H2) of the pulse width modulation signal (PWM) within at least a part of the period of one frame for the vertical synchronization signal.

### TECHNICAL FIELD

The present invention relates to a panel controller that is incorporated in electronic apparatuses such as a liquid crystal display apparatus and the like. In detail, the present invention relates to: a panel controller that performs a variety of signal modulation; a signal modulation method; a signal modulation program; a recording medium that records the program; and a liquid crystal display apparatus that incorporates the panel controller.

### BACKGROUND ART

Conventionally, there are many cases where a pulse width modulation (PWM) system is employed for a fluorescent lamp that is used as, for example, a light source of an illumination apparatus (backlight unit and the like) that is contained in a liquid crystal display apparatus. And, in a case of such a PWM system, there is a problem that a dimming signal (PWM signal) for controlling the fluorescent lamp interferes with a vertical synchronization signal for a liquid crystal display panel (e.g., a patent document 1).

### CITATION LIST

Patent Literature

PLT1: JP-A-1998-213789

### SUMMARY OF INVENTION

### Technical Problem

This problem is simply illustrated as shown in FIG. 11. FIG. 11, in order from top, shows: a vertical synchronization signal vs; next, a dimming signal pwm; and both signals vs, pwm with overlapping each other in front of a reticulated arrow. Here, as for each of the signals vs, pwm, a high is indicated by “H” while a low is indicated by “L”; the maximum signal value of the vertical synchronization signal vs is indicated by H101 while the minimum signal value of the vertical synchronization signal vs is indicated by L101; the maximum signal value of the dimming signal pwm is indicated by H102 while the minimum signal value of the dimming signal pwm is indicated by L102. Further, auxiliary lines (dotted lines) that indicate these signal values for easy understanding are so shown for convenience as not to overlap solid lines of the signal values. Besides, white arrows in this FIG. 11 and FIG. 12 described later represent time-passing directions.

And, as shown in FIG. 11, especially, in the diagram in which both signals vs, pwm overlap each other, a problem is that the maximum signal value H102 of the dimming signal pwm is higher than the minimum signal value L101 of the vertical synchronization signal vs (here, the minimum signal value L101 and the minimum signal value L102 are substantially the same value.). The reason for this is that in such a case, during one frame (one screen) period, if a high portion of the dimming signal pwm interferes with the vertical synchronization signal vs, a phenomenon occurs as described hereinafter.

The phenomenon is that in the case where the vertical synchronization signal vs and the dimming signal pwm interfere with each other during one frame period, caused by the signal value of the dimming signal pwm exceeding the minimum signal value L101 of the vertical synchronization signal (see a region enclosed by a two-dot-one-bar line), as shown in FIG. 12, on an image on a liquid crystal display panel 151, a large number of unnecessary images 199 are displayed (an appearance of such image 199 is called an image beat).

And, this image 199 becomes conspicuous, so that a user feels uncomfortable (here, the number of unnecessary images 199 during the one frame period in FIG. 12 becomes equal to the number of high portions of the vertical synchronization signal vs that cause the interference in the diagram of FIG. 11 in which both signals vs, pwm overlap each other.).

The present invention has been made to solve the above problems. And, it is an object of the present invention to provide a panel controller and the like that curb occurrence of an unnecessary image such that a human does not feel uncomfortable when the human watches a liquid crystal display panel.

### Solution to Problem

The panel controller controls a liquid crystal display panel that receives light from an illumination apparatus which is driven in accordance with a dimming signal. And, this panel controller makes an intermediate signal value, which is an intermediate value between a maximum signal value and a minimum signal value of a vertical synchronization signal, higher than a maximum signal value of the dimming signal during at least a partial period of one frame period of the vertical synchronization signal.

According to this, during one frame period, a time zone in which the dimming signal exceeds the vertical synchronization signal during one frame period becomes extremely short. Because of this, even if interference between the vertical synchronization signal and the dimming signal occurs during the one frame period, an unnecessary image, caused by a signal value of the dimming signal exceeding a signal value of the vertical synchronization signal, becomes extremely unlikely to appear on the liquid crystal display panel and the like.

Here, it is possible to say that a liquid crystal display apparatus, which includes: such a panel controller; a liquid crystal display panel whose display image is controlled by the panel controller; and an illumination apparatus that supplies light to the liquid crystal display panel, is also the present invention.

Besides, in a signal modulation method for the panel controller that controls the liquid crystal display panel which receives light from the illumination apparatus that is driven in accordance with the dimming signal, it is possible to say that the following method is also the present invention. In other words, it is the signal modulation method that makes the intermediate signal value, which is an intermediate value between the maximum signal value and the minimum signal value of the vertical synchronization signal, higher than the maximum signal value of the dimming signal during at least a partial period of the one frame period of the vertical synchronization signal.

Besides, in a signal modulation program for the panel controller that controls the liquid crystal display panel which receives the light from an illumination apparatus that is driven in accordance with the dimming signal, it is possible to say that the following signal modulation program is also the present invention. In other words, it is the signal modulation program which forces the panel controller to execute signal modulation that makes the intermediate signal value, which is the intermediate value between the maximum signal value and the minimum signal value of the vertical synchronization signal higher, than the maximum signal value of the dimming signal during at least a partial period of the one frame period of the vertical synchronization signal.

Besides, it is possible to say that a recoding medium, which is readable by a computer and records the signal modulation program, is also the present invention.

### Advantageous Effects of Invention

According to the present invention, if only the panel controller slightly changes the signal value of the vertical synchronization signal, it is possible to curb trouble (an unnecessary image appears on the liquid crystal display panel and the like: an image beat) caused by the signal value of the dimming signal exceeding the signal value of the vertical synchronization signal.

### BRIEF DESCRIPTION OF DRAWINGS

FIG. 1 is a descriptive view that shows a signal diagram illustrating a horizontal synchronization signal; a signal diagram illustrating a vertical synchronization signal; a signal diagram illustrating a dimming signal; and a plan view of a liquid crystal display panel.

FIG. 2 is a descriptive view that shows a signal diagram illustrating a vertical synchronization signal; a signal diagram illustrating a dimming signal; and a signal diagram in which both these signals overlap each other.

FIG. 3 is a plan view of a liquid crystal display panel that shows presence of an unnecessary image caused by the vertical synchronization signal and the dimming signal shown in FIG. 2.

FIG. 4 is a descriptive view that shows a signal diagram illustrating a vertical synchronization signal different from FIG. 2; a signal diagram illustrating a dimming signal; and a signal diagram in which both these signals overlap each other.

FIG. 5 is a plan view of a liquid crystal display panel that shows presence of an unnecessary image caused by the vertical synchronization signal and the dimming signal shown in FIG. 4.

FIG. 6 is a descriptive view that shows a signal diagram illustrating a vertical synchronization signal different from FIG. 2 and FIG. 4; a signal diagram illustrating a dimming signal; and a signal diagram in which both these signals overlap each other.

FIG. 7 is a plan view of a liquid crystal display panel that shows presence of an unnecessary image caused by the vertical synchronization signal and the dimming signal shown in FIG. 6.

FIG. 8 is an explosive perspective view of a liquid crystal display apparatus.

FIG. 9 is an enlarged explosive perspective view of a liquid crystal display apparatus.

FIG. 10 is a block diagram that shows various members incorporated in a liquid crystal display apparatus.

FIG. 11 is a descriptive view that shows a signal diagram illustrating a conventional vertical synchronization signal; a signal diagram illustrating a dimming signal; and a signal diagram in which both these signals overlap each other.

FIG. 12 is a plan view of a liquid crystal display panel that shows presence of an unnecessary image caused by the vertical synchronization signal and the dimming signal shown in FIG. 11.

### DESCRIPTION OF EMBODIMENTS

### Embodiment 1

An embodiment is described based on drawings as follows. Here, for convenience, there is a case where member numbers and the like are omitted; in such a case, other drawings are referred to.

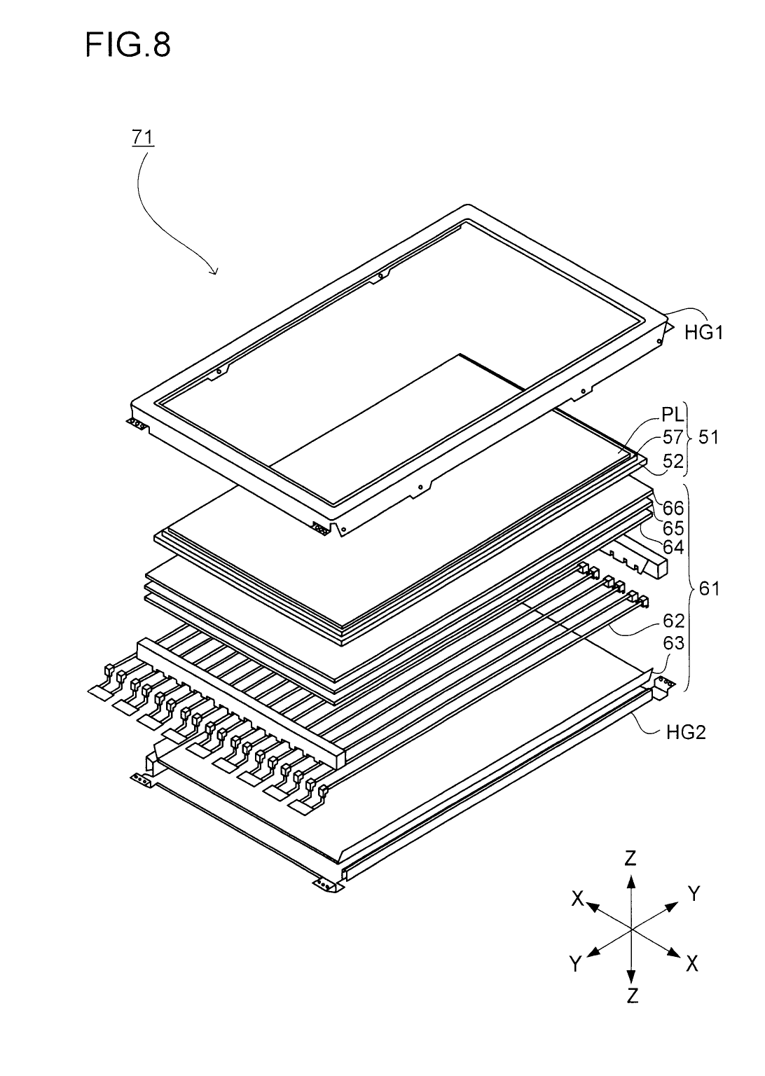

FIG. 8 is an explosive perspective view of a backlight type of liquid crystal display apparatus 71. As shown in this FIG. 8, the liquid crystal display apparatus (display apparatus) 71 includes: a liquid crystal display panel (display panel) 51; and a backlight unit (illumination apparatus) 61 that supplies light to the liquid crystal display panel 51. Here, this liquid crystal display panel 51 and the backlight unit 61 are housed in a housing (front housing HG1, rear housing HG2) that is an outer casing.

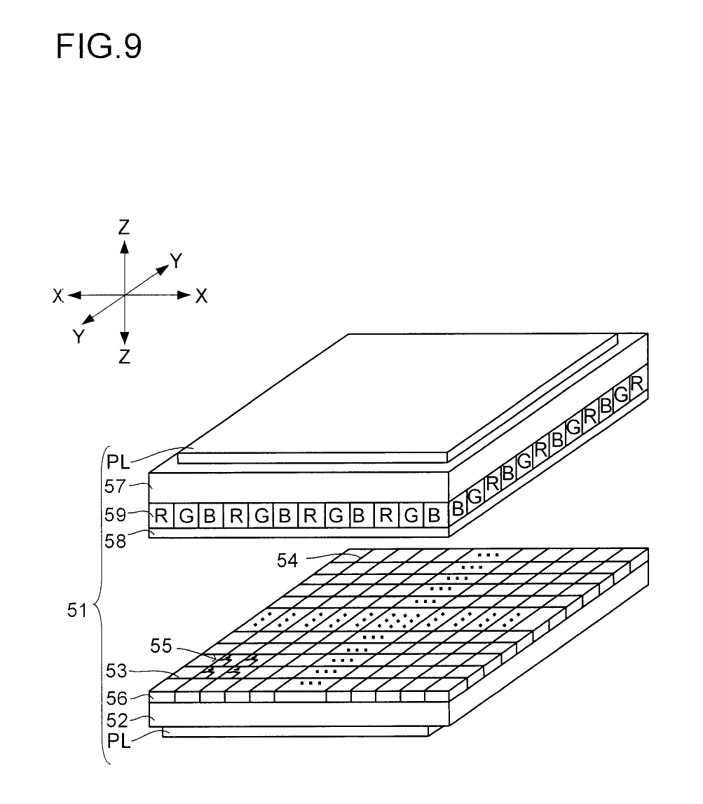

The liquid crystal display panel 51 employs an active matrix system. Because of this, as shown in FIG. 9 that is an enlarged perspective view, in this liquid crystal display panel 51, liquid crystal (not shown) is sandwiched by: an active matrix board 52 on which active devices (switching devices) such as a TFT (Thin Film Transistor) 55 and the like are mounted; and an opposite board 57 that faces this active matrix board 52. In other words, the active matrix board 52 and the opposite board 57 are boards for sandwiching the liquid crystal (here, both boards 52, 57 are formed of transparent glass, for example.).

As for the active matrix board 52, a surface that faces the opposite board 57 is provided with: a gate signal line 53; a source signal line 54; the TFT 55; and a pixel electrode 56 (here, of the active matrix board 52, on an opposite surface that does not face the opposite board 57, a light polarization plate PL is mounted.).

The gate signal line 53 is a line for flowing a gate signal (scan signal) that controls ON/OFF of the TFT 55; the source signal line 54 is a line for flowing a source signal (image signal) that is necessary for image display. And, these both lines 53, 54 are each arranged in a line.

In detail, on the active matrix board 52, the gate signal line 53 arranged in a line and the source signal line 54 arranged in a line intersect each other, so that these both lines 53, 54 are disposed into a matrix shape. Besides, regions divided by the gate signal line 53 and the source signal line 54 correspond to pixels of the liquid crystal display panel 51.

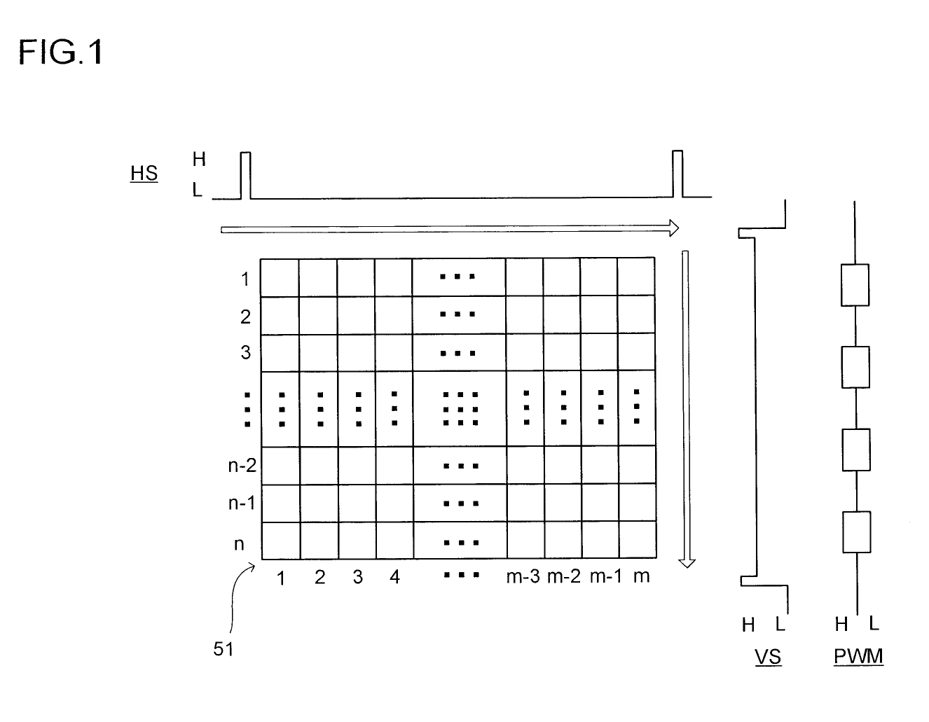

Besides, these pixels also, as shown in FIG. 1 described later, are disposed into a matrix shape. Accordingly, for convenience, rows of the pixels are numbered 1, 2, 3 . . . n (1 or larger natural numbers) while columns of the pixels are numbered 1, 2, 3 . . . m (1 or larger natural numbers).

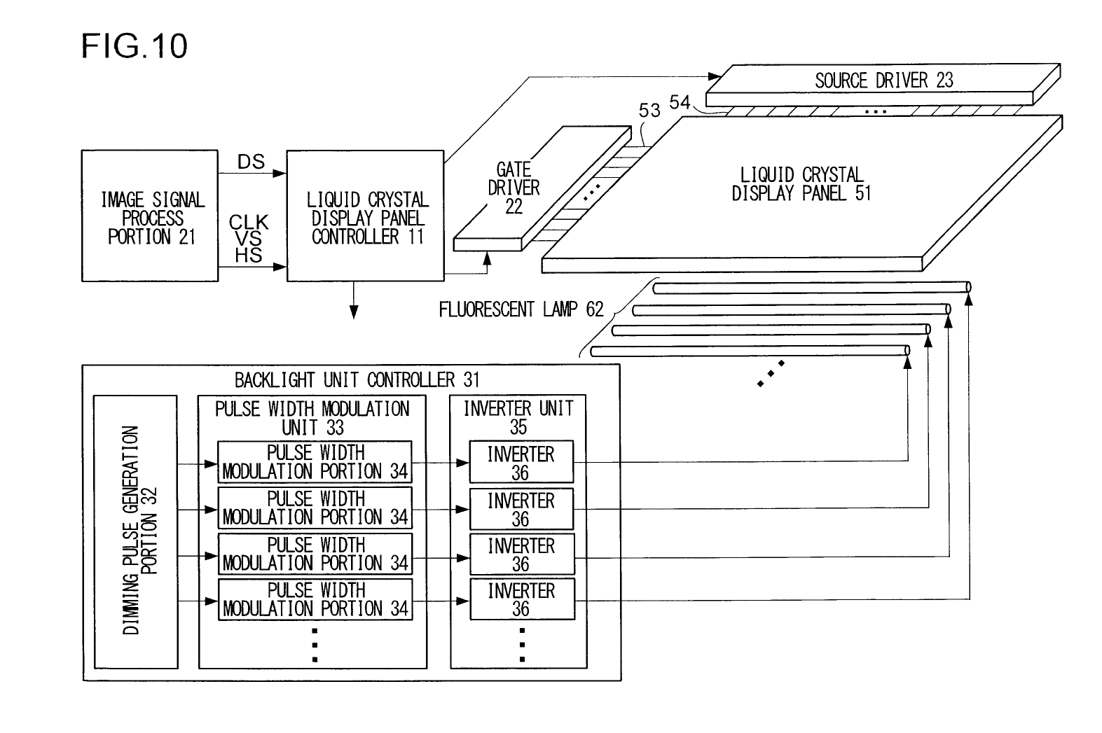

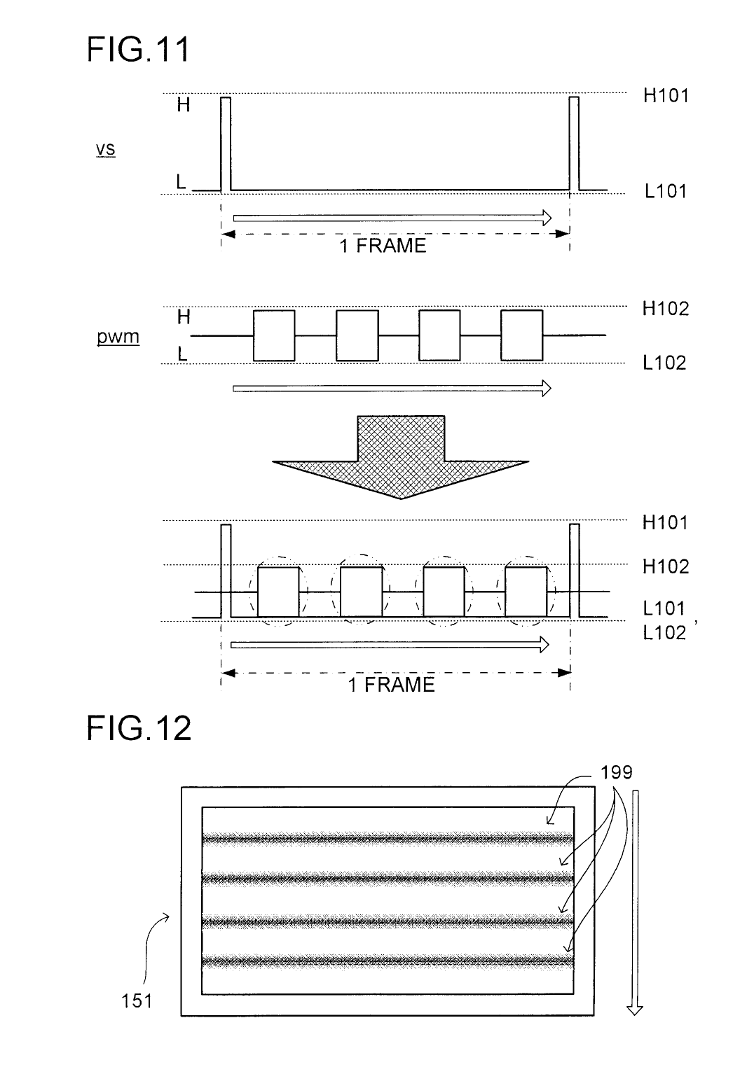

Here, the gate signal flowing in the gate signal line 53 is generated by a gate driver 22 while the source signal flowing in the source signal line 54 is generated by a source driver 23 (see FIG. 10 described later).

The TFT 55 is situated at an intersection of the gate signal line 53 and the source signal line 54; and controls ON/OFF of each pixel of the liquid crystal display panel 51 (here, only part of the TFTs 55 are shown for convenience.). In other words, this TFT 55 controls the ON/OFF of each pixel by means of the gate signal that flows in the gate signal line 53.

The pixel electrode 56 is an electrode that connects to a drain of the TFT 55 and is so disposed as to correspond to each pixel (in other words, the pixel electrodes 56 are laid tightly into a matrix shape on the active matrix board 52). And, the pixel electrode 56 collaborates with a common electrode 58 described later to sandwich the liquid crystal.

As for the opposite board 57, a surface that faces the active matrix board 52 is provided with: the common electrode 58; and a color filter 59 (here, of the opposite board 57, on an opposite surface that does not face the active matrix board 52, the light polarization plate PL is mounted.).

The common electrode 58, unlike the pixel electrode 56, is so disposed as to correspond to a plurality of pixels (in other words, on the opposite board 57, the common electrode 58 has an area to collectively cover the plurality of pixels.). And, the common electrode 58 collaborates with the pixel electrode 56 to sandwich the liquid crystal. As a result of this, the liquid crystal is controlled by a potential difference between the common electrode 58 and the pixel electrode 56.

The color filter 59 is a filter that transmits specific-color light. As an example, there are the color filters 59 of red (R), green (G), and blue (B) that are the three primary colors of light (here, R, G, an B in FIG. 9 mean colors of the color filters 59). Besides, these color filters 59 are disposed into, for example, a stripe shape, a delta shape, or a square shape.

And, in the above liquid crystal display panel 51, in a case where the TFT 55 is turned on by a gate signal voltage that is given via the gate signal line 53, a source signal voltage from the source signal line 54 is given to the pixel electrode 56 via a source and drain of the TFT 55. And, in accordance with the source signal voltage, the source signal voltage is written into the liquid crystal portion sandwiched by the pixel electrode 56 and the common electrode 58, that is, the pixel. On the other hand, in a case where the TFT is turned off, the source signal voltage continues to be held by the liquid crystal and a capacitor (not shown). In other words, thanks to the above ON/OFF of the TFT 55, the liquid crystal partially changes the transmission rate to form an image.

Next, a backlight unit 61 which supplies light to the above liquid crystal display panel 51 is described. The backlight unit 61, as shown in FIG. 8, includes: a fluorescent lamp 62; a reflection sheet 63; and an optical sheet group (64 to 66).

The fluorescent lamp 62 is a light source that is, for example, a cold cathode fluorescent lamp (CCFL); and a plurality of cold cathode fluorescent lamps are incorporated (here, in the figure, only part of the fluorescent lamps 62 are shown.). Here, for convenience, an arrangement direction of the fluorescent lamps 62 is called an X direction; an extension direction of the fluorescent lamp 62 is called a Y direction; and a direction which intersects the X direction and the Y direction at right angles is called a Z direction.

Besides, the fluorescent lamp 62 employs a pulse width modulation (PWM) system that changes, within a short period called a PWM period, a light amount in accordance with a change of a time ratio (Duty) between a turned-on time and a turned-off time. And, this light amount control is performed via a backlight unit controller 31 (see FIG. 10 described later).

The reflection sheet 63 is covered by the fluorescent lamps 62 that are tightly laid; and reflects light that travels from these fluorescent lamps 62, thereby guiding the light to the optical sheet group (64 to 66).

The optical sheet group (64 to 66) includes: a diffusion sheet 64; and prism sheets 65, 66. The diffusion sheet 64 is so situated as to cover the fluorescent lamps 62 that are tightly laid; diffuses surface light from the fluorescent lamps 62, thereby spreading the surface light throughout the liquid crystal display panel 51.

The prism sheets 65, 66 each are an optical sheet that has, for example, prism shapes on a sheet surface and changes a light radiation characteristic; and are so situated as to cover the diffusion sheet 64. Because of this, theses prism sheets 65, 66 collect light that travels from the diffusion sheet 64 to increase the brightness.

And, in the above backlight unit 61, the light from the fluorescent lamps 62 turns into the surface light and travels; the surface light passes through the optical sheet group (64 to 66) and exist as the backlight that has a high light emission brightness. And, this backlight reaches the liquid crystal display panel 51; thanks to the backlight, the liquid crystal display panel 51 displays an image.

Here, various circuits, which are contained in the liquid crystal display apparatus 71 that incorporates the above liquid crystal display panel 51 and backlight unit 61, are described by using FIG. 10. In detail, an image signal process portion 21; a liquid crystal display panel controller 11; a gate driver 22; a source driver 23; and the backlight unit controller 31, which are contained in the liquid crystal display apparatus 71, are described.

The image signal process portion 21 processes an image signal, for example, a television image-voice signal for a television broadcast or a video image-voice signal for a vide, thereby generating an image-voice processed signal. Here, in the following description, of an image processed signal and a voice processed signal that constitute the image-voice processed signal, the image processed signal is chiefly described.

The image processed signal includes: for example, a color image signal DS that is displayed on the liquid crystal display panel; and synchronization signals (clock signal CLK, vertical synchronization signal VS, horizontal synchronization signal HS and the like) relating to the color image signal. And, these signal are transmitted to the liquid crystal display panel controller 11 by the image signal process portion 21. Besides, the image signal process portion 22 may apply various correction processes such as γ correction, contrast correction, color space conversion process and the like to the color image signal.

The liquid crystal display panel controller 11, via: the gate driver 22; the source driver 23; and the backlight unit controller 31, performs control of the displayed image on the liquid crystal display panel 51 and drive-timing control of the backlight unit 61. In detail, the liquid crystal display panel controller 11 receives the synchronisation signal from the image signal process portion 21 and generates various timing signals. For example, the liquid crystal display panel controller 11 transmits the various timing signals to the gate driver 22, the source driver 23, and the backlight unit controller 31.

Specifically, the liquid crystal display panel controller 11 generates timing signals such as a gate clock signal (GCK), a gate start pulse (GSP) and the like and transmits them to the gate driver 22, while generates timing signals such as a source clock signal (SCK), a source start pulse (SSP) and the like and transmits them to the source driver 23. Besides, the liquid crystal display panel controller 11 generates a turning-on timing signal that synchronizes the driving (turning on /turning off) of the fluorescent lamp 62 with the driving of the liquid crystal display panel 51, and transmits the turning-on signal to the backlight unit controller 31.

The gate driver 22, based on the various timing signals such as the gate clock signal (GCK), the gate start pulse (GSP) and the like that are transmitted from the liquid crystal display panel controller 11, generates a gate signal and transmits the gate signal to the gate signal line 53.

The source driver 23, based on the various timing signals such as the source clock signal (SCK), the source start pulse (SSP) and the like that are transmitted from the liquid crystal display panel controller 11, applies sampling to the color image signal DS to generate a source signal and transmits the source signal to the source signal line 54.

In other words, in the case where an image is displayed on the liquid crystal display panel 51, the gate driver 22 and the source driver 23 operate as follows (here, a common voltage is applied to the common electrode 58 by a not-shown common electrode voltage control portion contained in the liquid crystal display panel controller 11.).

First, the gate driver 22 transmits the gate signal to each gate signal line 53, thereby successively turning on the TFTs for the respective pixels. And, the source driver 23, in synchronization with the timing of the gate signal transmission by the gate drive 22 to each gate signal line 53, transmits the source signal to the source signal line 54. Accordingly, a potential difference between the pixel electrode 56 and the common electrode 58 changes in accordance with the source signal, whereby the liquid crystal changes its state. As a result of this, the light amount from the backlight unit 61 passes through the liquid crystal to change, so that an image corresponding to the source signal is displayed on the liquid crystal display panel 51.

The backlight unit controller 31 controls the fluorescent lamp 62 and includes: a dimming pulse generation portion 32; a pulse width modulation unit 33; and an inverter unit 35.

The dimming pulse generation portion 32 includes a reference signal generator (not shown) that generates a reference oscillation clock; and based on the clock, generates a dimming signal.

The pulse width modulation unit 33 includes a plurality of pulse width modulation portions 34 corresponding to each fluorescent lamp 62. And, the pulse width modulation portion 34 receives the dimming signal from the dimming pulse generation portion 32; and modulates a pulse width and pulse period of the dimming signal (here, such modulated dimming signal is also called a PWM signal.).

The inverter unit 35 includes a plurality of inverters 36 corresponding to each fluorescent lamp 62 and to each pulse width modulation portion 34. And, the inverter 36, based on the dimming signal generated by the pulse width modulation portion 34, adjusts an electric current supplied from a power supply (not shown); generates a light emission signal that controls light emission from the fluorescent lamp 62; and transmits the light emission signal to the fluorescent lamp 62. As a result of this, the light emission from the fluorescent lamp 62 is controlled by the backlight unit controller 31.

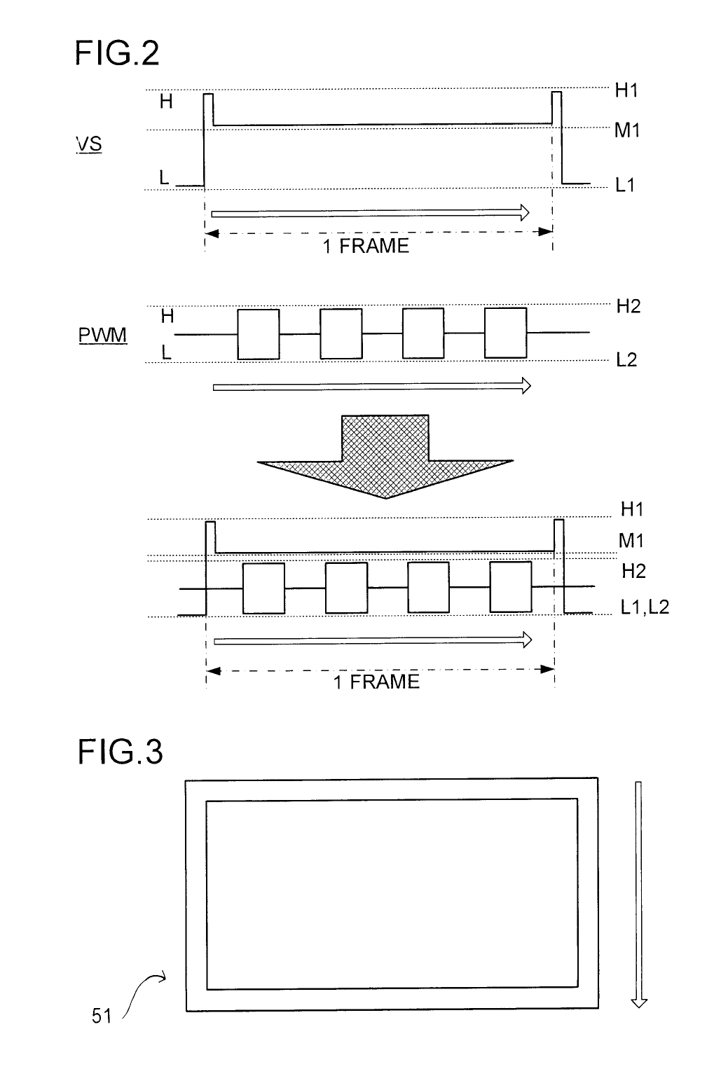

Next, various signals in the liquid crystal display apparatus 71 are described by using FIG. 1 and FIG. 2.

FIG. 1 shows the liquid crystal display panel 51 that indicates pixels disposed in a matrix shape; and three kinds of signal diagrams. Here, “H” and “L” indicated in correspondence with each signal line mean a high and a low of a signal, respectively; white line arrows mean time-passing directions of a signal (here, the white arrow corresponding to the vertical synchronization signal VS means that time passes in a row order of the pixels, that is, a first row, a second row, n-th row while the white arrow corresponding to the horizontal synchronization signal HS means that time passes in a column order of the pixels, that is, a first column, a second column, . . . , m-th column.).

And, the three kinds of signals include: the vertical synchronization signal VS and the horizontal synchronization signal HS that are controlled by the liquid crystal display panel controller 11; and the dimming signal PWM that is controlled by the backlight unit controller 31. Besides, FIG. 2, in order from top, shows the vertical synchronization signal VS, the dimming signal PWM; and illustrates a diagram, in front of a reticulated line arrow, in which the vertical synchronization signal VS and the dimming signal PWM overlap each other.

Here, as shown in FIG. 2, of the vertical synchronization signal VS, the maximum signal value is indicated by H1; the minimum signal value is indicated by L1; and an intermediate signal value, which is an intermediate value between the maximum signal value H1 and the minimum signal value L1, is indicated by M1. Besides, of the dimming signal PWM, the maximum signal value is indicated by H2; and the minimum signal value is indicated by L2 (here, auxiliary lines (dotted lines) that indicate the maximum signal values, the minimum signal values, and the intermediate signal value for easy understanding are so shown for convenience as not to overlap the solid lines of the signal values.).

According to this, as shown in front of the reticulated line arrow in FIG. 2, the minimum signal value L2 of the dimming signal PWM and the minimum signal value L1 of the vertical synchronization signal VS have substantially the same value (L2≈L1). However, the maximum signal value 112 of the dimming signal PWM is smaller than the intermediate signal value M1 of the vertical synchronization signal VS (H2<Ml<H1). In other words, the liquid crystal display panel controller 11, for the entire period of one frame period of the vertical synchronization signal VS, makes the intermediate signal value M1 of the vertical synchronization signal VS higher than the maximum signal value 112 of the dimming signal PWM.

According to this, even if the vertical synchronization signal VS and the dimming signal PWM interfere with each other, the signal value of the intermediate signal value M1 of the vertical synchronization signal VS during one frame (one screen) period exceeds the signal value of the dimming signal PWM. Because of this, an unnecessary image, caused by the signal value of the dimming signal PWM exceeding the signal value of the vertical synchronization signal VS during the one frame period, does not appear on the liquid crystal display panel 51 as shown in FIG. 3 (an unnecessary image 99 as shown in FIG. 5 and FIG. 7 described later is not displayed on the liquid crystal display panel 51.).

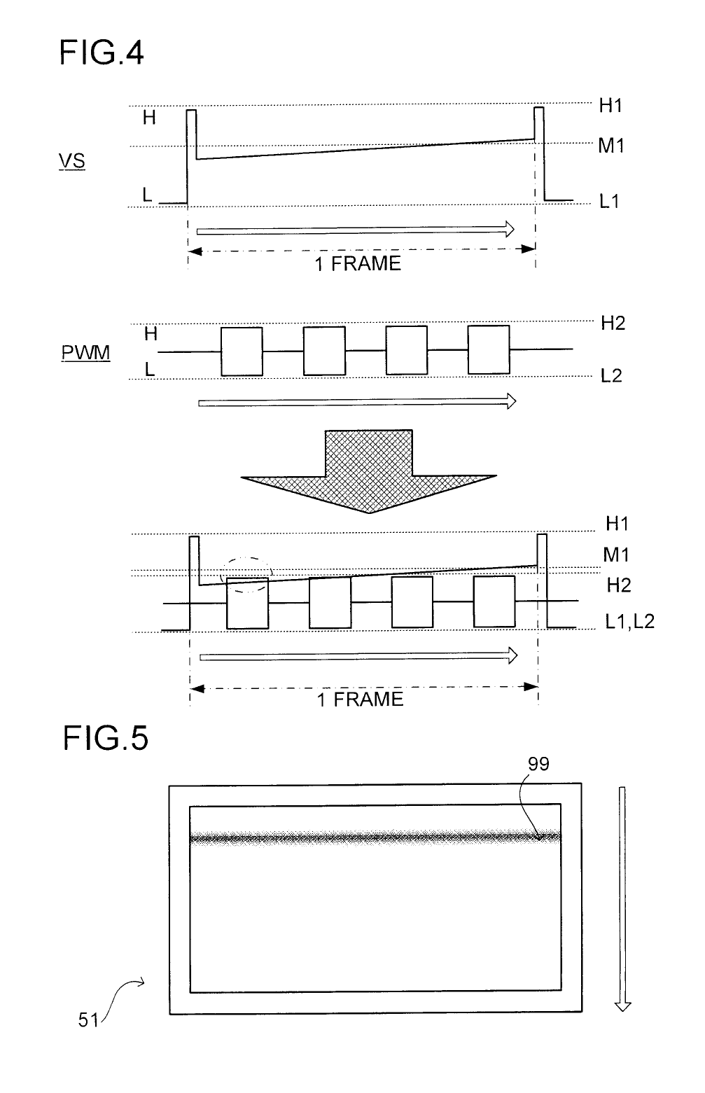

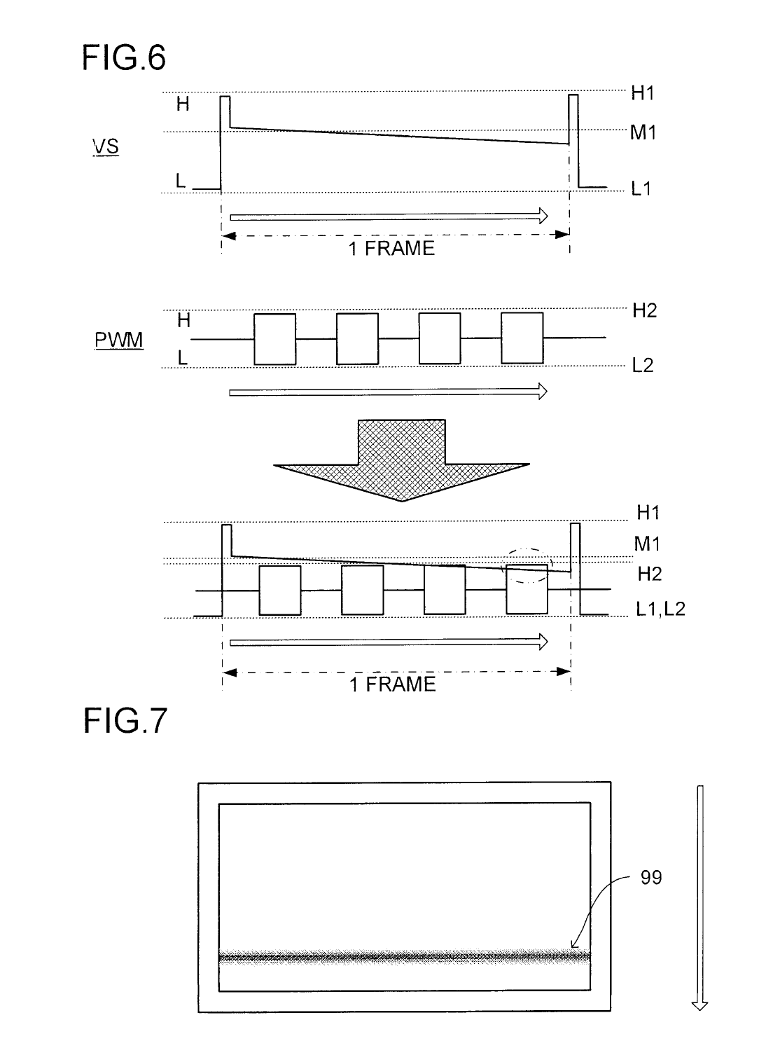

Here, as shown in the diagram of FIG. 2 in which the vertical synchronization signal VS and the dimming signal PWM overlap each other, it is most desirable that during the entire period of the one frame period of the vertical synchronization signal VS, the constant-value intermediate signal value Ml is higher than the maximum signal value 112 of the dimming signal PWM; however, this is not limiting: states shown in FIG. 4 and FIG. 6 are acceptable.

In other words, as shown in diagrams of FIG. 4 and FIG. 6 that illustrate the vertical synchronization signal VS only, the intermediate signal value M1 that is the intermediate value between the maximum signal value H1 of the vertical synchronization signal VS and the minimum signal value L1 of the vertical synchronization signal VS may have a signal waveform (see FIG. 4) that does not have a constant value and gradually increases as time passes; or may have a signal waveform (see FIG. 6) that gradually becomes low as time passes.

However, as shown in diagrams of FIG. 4 and FIG. 6 in which the vertical synchronization signal VS and the dimming signal PWM overlap each other, the intermediate signal value M1 during at least a partial period of the one frame period of the vertical synchronization signal VS must be higher than the maximum signal value H2 of the dimming signal PWM.

According to this, even if the vertical synchronization signal VS and the dimming signal PWM interfere with each other, most signal values of the intermediate signal value M1 of the vertical synchronization signal VS during the one frame period exceed the maximum signal value H2 of the dimming signal PWM. In other words, only part of the signal values of the intermediate signal value M1 of the vertical synchronization signal VS during the one frame period do not exceed the maximum signal value H2 of the dimming signal PWM (see regions enclosed by two-dot-one-bar lines in FIG. 4 and FIG. 6).

Because of this, during the one frame period, caused by the signal value of the dimming signal PWM exceeding the signal value of the vertical synchronization signal VS, the unnecessary image 99 slightly appears on the liquid crystal display panel 51 as shown in FIG. 5 and FIG. 7. However, even if the unnecessary image 99 appears for an extremely short instant during the short period of one frame period, a human is unlikely to feel uncomfortable. Because of this, generally, a human does not feel uncomfortable watching the image on the liquid crystal display panel 51.

### Other Embodiments

Here, the present invention is not limited to the above embodiments, and various modifications are possible without departing from the spirit of the present invention.

For example, in the above liquid crystal display apparatus 71, the image signal process portion 52 processes the image signal of the image-voice signal. Because of this, it is possible to say that a receiving apparatus incorporating such liquid crystal display apparatus 71 is a television broadcast receiving apparatus (so-called liquid crystal television). However, the image signal processed by the above liquid crystal display apparatus 71 is not limited to a television broadcast. For example, the image signal may be an image signal that is recorded in a recording medium which records content such as a movie and the like; or may be an image signal that is transmitted via the Internet.

Besides, the signal modulation process of the vertical synchronization signal

VS by the liquid crystal display panel controller 11 is achieved by a signal modulation program. And, this signal modulation program is a program executable on a computer and may be recorded in a recording medium that is readable by the computer. The reason for this is that a program recorded in a recording medium is mobile.

Here, as this recording medium, for example, there are tape relatives such as a separable magnetic tape, a cassette tape and the like; disc relatives such as a magnetic disc, an optical disc like a CD-ROM and the like; card relatives such as an IC card (a memory card is included), an optical card and the like; and semiconductor memory relatives such as a flash memory and the like.

Besides, the liquid crystal display panel controller 11 may obtain the signal modulation program over communication from a communication network. Here, as the communication network, by cable or wireless, there are the Internet, an infrared-rays communication network and the like.

### REFERENCE SIGNS LIST

11 liquid crystal display panel controller (panel controller)

21 image signal process portion

22 gate driver

23 source driver

31 backlight unit conroller

32 dimming pulse generation portion

33 pulse width modulation unit

35 inverter unit

51 liquid crystal display panel (display panel)

52 active matrix board

53 gate signal line

54 source signal line

55 TFT

56 pixel electrode

57 opposite board

58 common electrode

59 color filter

61 backlight unit (illumination apparatus)

62 fluorescent lamp

71 liquid crystal display apparatus (display apparatus)

H1 maximum signal value of vertical synchronization signal

L1 minimum signal value of vertical synchronization signal

M1 intermediate signal value of vertical synchronization signal

H2 maximum signal value of dimming signal

L2 minimum signal value of dimming signal

1. A panel controller that controls a liquid crystal display panel which receives light from an illumination apparatus that is driven in accordance with a dimming signal, the panel controller makes an intermediate signal value, which is an intermediate value between a maximum signal value and a minimum signal value of a vertical synchronization signal, higher than a maximum signal value of the dimming signal during at least a partial period of one frame period of the vertical synchronization signal.

2. A liquid crystal display apparatus comprising:
the panel controller described in claim 1;
a liquid crystal display panel whose display image is controlled by the panel controller; and
an illumination apparatus that supplies light to the liquid crystal display panel.

3. A signal modulation method for a panel controller that controls a liquid crystal display panel which receives light from an illumination apparatus that is driven in accordance with a dimming signal, the signal modulation method makes an intermediate signal value, which is an intermediate value between a maximum signal value and a minimum signal value of a vertical synchronization signal, higher than a maximum signal value of the dimming signal during at least a partial period of one frame period of the vertical synchronization signal.

4. A signal modulation program for a panel controller that controls a liquid crystal display panel which receives light from an illumination apparatus that is driven in accordance with a dimming signal, the signal modulation program forces the panel controller to execute signal modulation that makes an intermediate signal value, which is an intermediate value between a maximum signal value and a minimum signal value of a vertical synchronization signal, higher than a maximum signal value of the dimming signal during at least a partial period of one frame period of the vertical synchronization signal.

5. A recoding medium that is readable by a computer and records the signal modulation program described in claim 4.
